(19) United States
(12) Patent Application Publication
(10) Pub. No.: US 2013/0218902 A1
(43) Pub. Date: Aug. 22, 2013

(54) SHARED DIRECTORY SYSTEM

(71) Applicants: Vlad Vendrow, San Mateo, CA (US); Vi Dinh Chau, San Mateo, CA (US)

(72) Inventors: Vlad Vendrow, San Mateo, CA (US); Vi Dinh Chau, San Mateo, CA (US)

(73) Assignee: Ring Central, Inc., San Mateo, CA (US)

(21) Appl. No.: 13/399,343

(22) Filed: Feb. 17, 2012

(51) Int. Cl. G06F 17/30

(52) U.S. Cl. 707/748; 707/758; 707/E17.014

(57) ABSTRACT

A directory system aggregates and synchronizes contact information across users, devices, and services. The directory system may aggregate contact information globally or across groups or organizations. The directory system may synchronize contact information for different users and resolve conflicts between inconsistent entries for a given entity. The directory system also may provide user-customized views of aggregated and synchronized contact information and list search results according to different attributes or based on relationships the search results may have with the user performing the search.

### BACKGROUND

A known on-line phone directory may provide a list of names and phone numbers in response to a name request entered by a user. However, the on-line phone directory may be incomplete. For example, the phone directory may only identify phone numbers for land-line based home telephones or for phone numbers associated with a particular telephone service carrier. The phone numbers in the on-line directory also may be out-of-date if a person associated with one of the phone numbers changes jobs, moves, and/or cancels phone service.

The on-line phone directory may provide a list of multiple similar names in response to a search query. The user may not know which of the names is associated with the correct person or company. In another example, the user may not know the full name of a person or know the correct spelling for the person. Entering a last name may yield hundreds or thousands of names from the on-line phone directory, and the on-line phone directory has little chance of identifying the correct number if the user only knows the first name of the person. The user may narrow down the list of names by entering address information. However, the user may not know the home or business address for the person.

A user may keep an electronic address book for different contacts. However, the address book must be updated each time contact information changes for one of the contacts. Further, the number of entries in the address book is usually relatively short and often may not contain names of individuals or companies the user needs to call or email. Known systems exist for synchronizing contact information between different users. However, the users are still limited to the relatively small number of contacts in their personal address book.

### BRIEF DESCRIPTION OF FIGURES

FIG. 1 depicts an example of a directory system.

FIG. 2 depicts an example of a process for aggregating contact information from different sources.

FIG. 3 depicts an example of a system for searching aggregated contact information.

FIG. 4 depicts an example of a system for identifying relationships between different contact information.

FIG. 5 depicts an example of a user profile in a directory.

FIG. 6 depicts an example of a process for searching through contact information in a directory.

FIG. 7 depicts an example of a process for ranking contact information.

FIG. 8 depicts an example of a process for ranking search results based on contact records.

FIG. 9 depicts an example of a distributed directory system.

FIG. 10 depicts an example of a process for synchronizing contact information.

FIG. 11 depicts an example of a device 500 configured to display a ranked list of names for companies.

FIG. 12 depicts an example of a device configured to display a ranked list of names for people.

FIG. 13 depicts an example of a device configured to display multiple ranked lists.

FIG. 14 depicts an example of a device configured to initiate calls to phone numbers associated with a list of names.

FIG. 15 depicts an example of a device configured to create a directory record.

FIG. 16 depicts an example of a device configured to access an account on a directory system.

FIG. 17 depicts an example of a device configured to upload contacts from an address book to a directory system.

FIG. 18 depicts an example of a device configured to control visibility settings for directory records.

### DETAILED DESCRIPTION

A directory system aggregates and synchronizes contact information across users, devices, and services. The directory system may aggregate contact information globally or across groups or organizations. In the case of a global directory, a database entry can be seen as a universal identifier for an individual. Although the contact information for the individual may change over time, a reference to the database entry can provide a persistent link to the individual's contact information. The directory system may synchronize user contact information and resolve conflicts between inconsistent entries for a given entity.

The directory system also may provide user-customized views of aggregated and synchronized contact information. For example, a user can search the directory system for contact information using different fields associated with the contact information, such as a name. The directory system can search the directory according to different attributes or based on relationships the search results may have with the user performing the search, such as user contacts, user contact history, and current user location.

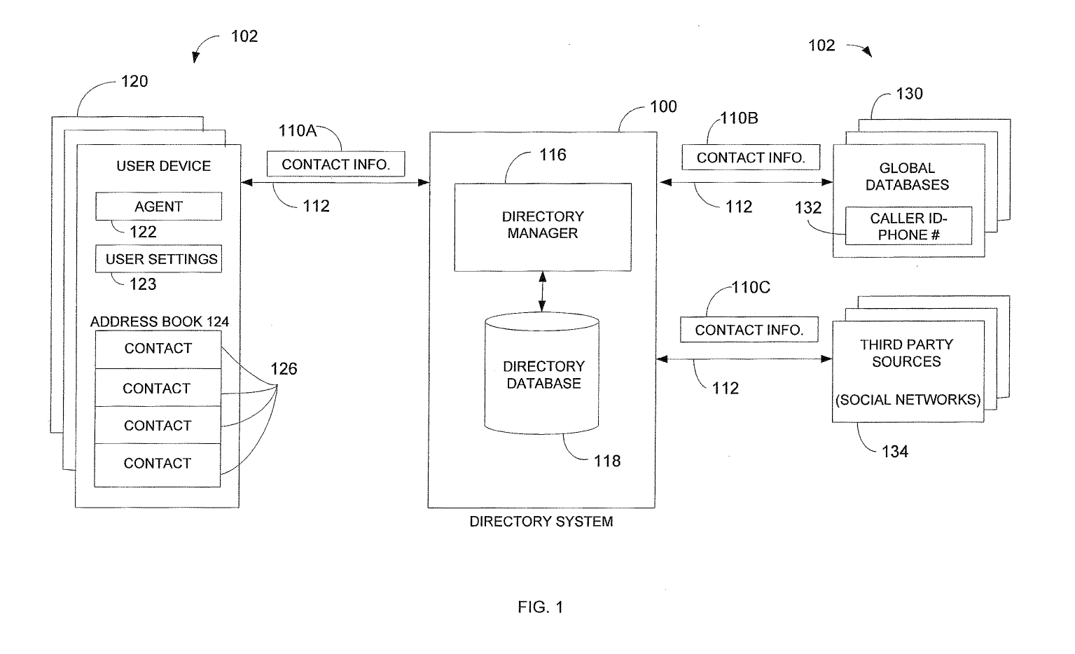

FIG. 1 depicts an example of a directory system 100 configured to aggregate contact information 110 from different sources 102. In one example, directory system 100 may comprise a directory manager 116 and a directory database 118. Sources 102 may include any combination of user devices 120, global databases 130, and third party sources 134.

In one example, a network 112 may connect sources 102 to directory system 100. Network 112 may comprise any combination of local area networks (LANs), wide area networks (WANs), Internet Protocol (IP) networks, phone networks, Public Services Telephone Networks (PSTN), wireless networks, cellular networks, Wi-Fi networks, Bluetooth networks, cable networks, data buses, or the like, or any combination thereof used for transferring information between sources 102 and directory system 100.

Directory manager 116 may manage the aggregation of contact information 110 from the sources 102 into directory database 118 and may search for contact information in directory database 118 in response to search requests from users. Directory manager 116 also may synchronize contact information 110 in directory database 118 received from different sources 102. Directory system 100 may operate in a central globally accessible server, gateway, or any other computing device configured to exchange data with different sources. For example, directory system 100 may operate on a publically accessible web server and sources 102 may communicate with directory manager 116 via an Internet network 112. In another example, directory system 100 may operate in a private or semi-private enterprise network and some of sources 102 may be associated with computers or servers operated by the enterprise. In another example, portions of directory database 118 and some of the operations performed by directory system 100 may be distributed on sources 102. In yet another example, directory system 100 may operate locally on one of sources 102.

User devices 120 may comprise any computing device operated by a user for communicating with directory system 100. For example, user devices 102 may comprise tablet computers, hand-held devices, smart telephones, mobile telephones, personal digital assistants (PDAs), laptop computers, personal computers, computer terminals, PSTN telephones, voice over Internet protocol (VoIP) phones, or the like, or any combination thereof. In another example, user devices 120 may include computers, such as servers, that communicate with directory system 100 through application programming interfaces (APIs) in order to provide directory services to other users.

In one example, some user devices 120 may store address books 124. Address books 124 may contain contacts 126 associated with the users of devices 120. Contacts 126 may include personal contact information for the user and contact information for affiliates of the user, such as friends, companies, business acquaintances, or any other entity. For example, contact information for contacts 126 may comprise a name, phone numbers, mailing addresses, a title, and/or email addresses. The phone numbers may include a home telephone number, a cellular telephone number, and/or a business telephone number. The mailing address and email address may include personal, social, and/or company addresses. Contacts 126 may contain any other information associated with an entity, such as photographs or links to social network sites.

User device 120 also may store user settings 123 that determine how an agent or application 122 operating in user device 122 operates in conjunction with directory system 100. For example, user settings 123 may determine what contact information 110A from contacts 126 in address book 124 are uploaded into directory system 100. In another example, user settings 123 may identify contact information 110B and/or 110C for uploading from other sources 130 and 134, respectively. User settings 123 are described in more detail below.

Global databases 130 may comprise any contact information 110B that may be associated with an entity. For example, one of global databases 130 may contain caller identifiers (Ids) and associated phone numbers 132. In other examples, global databases 130 may include on-line white pages and/or on-line yellow pages, business directories, university directories, email directories, domain name directories, address books for different entities, website directories, or the like, or any combination thereof.

Third party sources 134 may comprise social networks, websites, blogs, or any other source of contact information 110C associated with the users of directory system 100. For example, third party sources 134 may include social networks such as LinkedIn®, Facebook®, MySpace®, Twitter®, Google+®, or the like, or any combination thereof. Contact information 110B and 110C may comprise addresses, phone numbers, contacts in address books, profile information, social network associations, pictures, or the like, or any combination thereof that may be associated with a person, company, or any other entity.

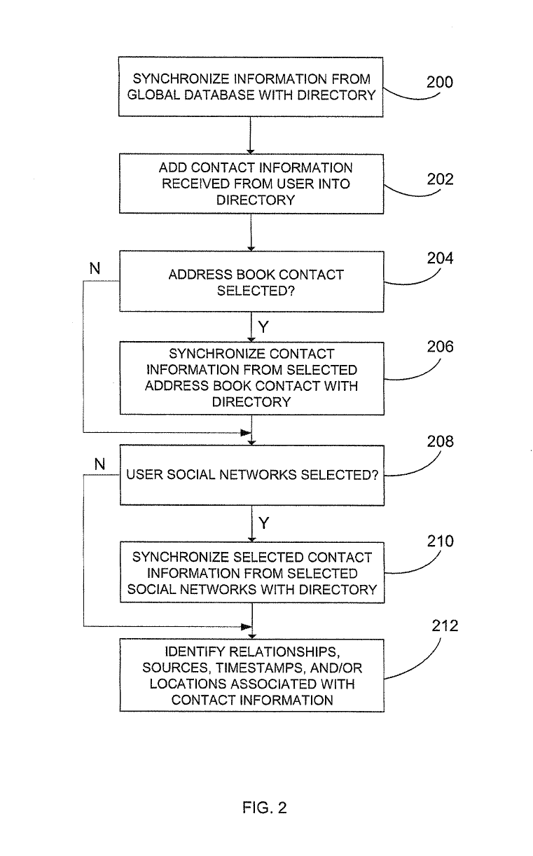

FIG. 2 depicts an example of a process for aggregating contact information from different sources. In operation 200, the directory system may upload contact information from global databases. For example, caller Ids and associated names from different publically accessible databases may be added to the directory database 118 in FIG. 1. In one example, in operation 200, the directory system may periodically access global databases to synchronize changes (e.g., additions, deletions, and modifications) to contact information on global databases.

In operation 202, contact information is entered directly into the directory system by the user. For example, users may call or log into the directory system and create directory records in directory database 118. The directory records may include contact information such as a name, mailing addresses, phone numbers, and email addresses. The contact information may be personal information of the user or may be contact information for friends, companies, acquaintances, or any other entities.

In operation 204, user settings in the user device may identify contacts in a user address book for uploading to the directory system. Contact information for the selected contacts then may be added to the directory system in operation 206. For example, names, phone numbers, mailing address, email addresses, etc. may be uploaded from the user address book to the directory system. In one example, the personal contact information for the user may be contained in the user address book and also may be selected for uploading to the directory system. In another example, in operation 206, changes (e.g., additions, deletions, and modifications) to any of the selected contacts may be automatically uploaded from the user address book to the directory system.

In operation 208, the user settings may identify social networks for uploading contact information. For example, the user settings may identify a HTTP link, a user login, and a user password for a particular social network. In operation 210, directory system 100 may access the social network and download contact information for the user, friends of the user, and/or any other contact information on the social network associated with the user. In one example, the user may select contacts or groups of contacts to upload to the directory system. In another example, in operation 210, directory system 100 may periodically access the social network to synchronize changes (e.g., additions, deletions, and modifications) to contact information for the user, friends of the user, and/or any other contact information for the user, friends of the user, and/or any other contact information on the social network associated with the user.

As explained above, other global databases or third party sources also may be identified via the user settings or accessed by the directory system independently of the user settings. For example, contact information from white page directories, yellow page directories, caller Id databases, etc. also may be aggregated with the other user contact information downloaded from the other sources.

In operation 212, relationships may be identified between the users and the contact information in the directory. The relationships may identify degrees of separation between the user and the contact information. For example, contact information obtained from a user address book may be identified as having a first degree of separation with the user. Contact information obtained from the address books of the contacts in a user address book may be identified as having a second degree of separation relationship with the user. The contact information also may be tagged to identify particular relationships with the user, such as a friend, a friend of a friend, father, mother, sibling, co-worker, classmate, etc.

Other tags and relationships also may be associated with the contact information. For example, the source of the contact information may be identified and an associated tag added to a directory record containing the contact information. The tags may identify the source of the contact information as an address book, social network, global database, third party sources, white pages, etc. The tags may also identify categories associated with the contact information, such as personal, professional, business, etc.

Timestamps may be assigned to the contact information. For example, a time stamp may identify when the contact information was added to the directory system, when the contact information was last updated, when a user last accessed the source for the contact information, etc.

Locations may be identified for the contact information. For example, a mailing address for a business may be identified in the contact information. In another example, the location may be based on Internet Protocol (IP) address associated with the contact information or based on an area code of a phone number associated with the contact information. Any other relationships or associations between the users and the contact information may be identified.

Aggregating together contact information from different users and identifying associations between the users and the contact information provide a powerful tool for quickly identifying relevant contact information. For example, users often may need to contact a person or a company that the user has previously contacted, that has previously contacted the user, that an acquaintance of the user has previously contacted, or that has previously contacted an acquaintance of the user. In other words, persons or companies that a user may need to contact often are within a few degrees of contact separation from the user.

The directory system uses this fact to identify more relevant contact information for user search requests. For example, a user may initiate a search request for a name. The directory system may search across the contacts of the user for a matching name and also may search across the contacts of friends, friends of friends, businesses, etc. The person or company associated with the name may have previously been contacted either by the user or an acquaintance of the user, or may have previously contacted either the user or an acquaintance of the user. Therefore, the search conducted by the directory system is more likely to identify the correct name. The directory system uses degrees of contact separation and other relationship identifiers to quickly identify relevant contact information.

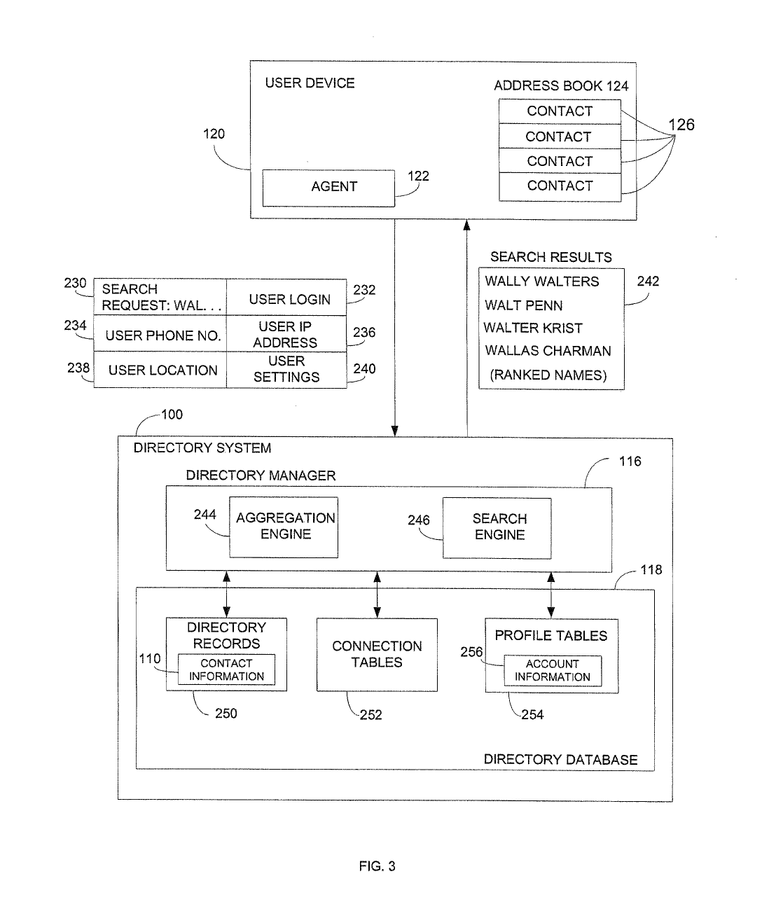

FIG. 3 depicts an example of a directory system configured to search through aggregated contact information. For explanation purposes, directory manager 116 is shown abstracted into different functional engines. However, it should be understood that any combination of hardware and/or software may be used for implementing aggregation, searching and ranking operations described below. Also, for explanation purposes, directory database 118 is shown abstracted into directory records 250, connection tables 252, and profile tables 254. It should be understood that any variety of database indexing schemes may be used for organizing connection information in directory database 118 and identifying relationships between the contact information, users, and search requests.

In one example, a directory aggregation engine 244 uploads and aggregates contact information 110 from multiple different sources. Aggregation engine 244 may create directory records 250 containing contact information 110. As discussed above, contact information 110 may include any combination of names, mail addresses, email addresses, phone numbers, etc. Contact information 110 may be uploaded directly into the directory system 100 by users via phone or user devices 120. Other contact information 110 may be downloaded from or synchronized with global databases and third party sources, such as social networks. Directory records 250 may be assigned unique identifiers that associate the contact information with a particular user or entity.

Aggregation engine 244 also may create profile tables 254 that contain contact information, account information 256, and other settings for users. Aggregation engine 244 also may create connection tables 252 that identify connections or relationships between different directory records 250 and profile tables 254.

A user may log into the directory system 100 and upload personal contact information 110, account information 256, and settings. Aggregation engine 244 may generate a profile table 254 and/or directory records 250 associated with the user. The user also may select contacts 126 in address book 124 for uploading to or synchronization with directory system 100. Aggregation engine 244 may create directory records 250 that contain contact information 110 for the contacts 126. Aggregation engine 244 also may generate entries in connection table 252 identifying the relationships between the user of device 120 and contact information 110 uploaded from or synchronized with address book 124. For example, the connection table 252 may identify degrees of separation between the user and the contact information for contacts 126.

In another example, the user may identify social networks for uploading contact information 110. Aggregation engine 244 may generate other directory records 250 containing contact information 110 downloaded from or synchronized with the social networks. Aggregation engine 244 may create additional entries in connection tables 252 or directory records 250 identifying the degrees of separation between the user and the contact information from the social networks.

User device 120 may send a search request 230 to directory system 100. In one example, search request 230 may identify all or part of a name. In another example, search request may identify all or part of a phone number. Other information associated with the user may be identified with search request 230. For example, search request 230 may be entered after the user logs into the directory system 100. User login information 232 may be associated with search request 230.

In another example, a caller ID, area code, or phone number 234 used for connecting to directory system 100 may be identified and associated with search request 230. In yet another example, an IP address 236 associated with user device 120 may be identified or associated with search request 230. In yet another example, location information 238 for user device 120 may be identified and sent with search request 230. For example, user device 120 may comprise a mobile smart phone with a global positioning system (GPS) that identifies a geographical location 238. This geographical location 238 may be sent with search request 230.

User search settings 240 also may be sent along with search request 230. For example, user settings 240 may identify a search category for search request 230, such as for a person, company, most recent calls, geographical location, etc.

A search engine 246 may conduct a search in directory database 118 based on search request 230 and any associated user identification information 232-240. Search engine 246 may locate a profile table 254 associated with the user initiating search request 230 and may identify additional search settings and personal information associated with the user in account information 254. Search engine 246 then may identify directory records 250 with contact information 110 matching the search term in search request 230 and that also may have some relationship with the user. For example, search engine 246 may identify matching contact information 110 within one degree of separation from the user, which can be determined during the search or by reference to connection tables 252.

Based on the amount of matching contact information 110, search engine 246 also may identify contact information 110 within two or more degrees of separation from the user. For example, search engine 246 may identify matching contact information 110 from the address books of contacts 126.

Directory system 100 may send a ranked list 242 of matching contact information back to user device 120 in response to search request 230. For example, search engine 246 may identify multiple names matching the search term in search request 230. Some of the names may be one degree of separation from the user and other names may be two or more degrees of separation from the user.

Search engine 246 may rank the identified names based their degrees of separation from the user. For example, names with one degree of separation from the user may be ranked higher than names with two or more degrees of separation from the user. Names with one degree of separation may have come from user address book 124 or may have come from a social network where the user is a member. Names with two or more degrees of separation from the user, or names with no relationship to the user, may have a lower likelihood of providing the correct name for search request 230. Therefore, the names with one degree of separation from the user may be ranked higher in list 242 than names with two or more degrees of separation from the user. In another example, names may be connected by a certain degree of separation through more than one path of relationships. For example, a first name may be connected to the user through three of the user's friends, and a second name may be connected to the user through one of the user's friends. The name with more connections through paths of relationships may have a higher likelihood of providing the correct name for a search request 230. Therefore, names with a higher number of connections through paths of relationships may be ranked higher in the list 242 than names with a lower number of connections through paths of relationships.

The identified names in list 242 also may be ranked based on geographical locations. For example, if two names have a same degree of separation from the user, the name with a closer geographical location to the user may be ranked higher. In another example, matching names that have been previously called by the user may be ranked higher than other matching names that have not recently been called by the user. In yet another example, names uploaded from a user address book may be ranked higher than names uploaded from a social network, and names uploaded from the social network may be ranked higher than names uploaded from a global database where the user has no membership affiliation.

Directory system 100 may include associated telephone numbers, email addresses, mailing addresses, etc. with the names in list 242. The user may select one of the names from list 242, and directory system 100 may provide details about the contact corresponding to the selected name. The user may then select a telephone number, e-mail address, or other contact information to initiate a communication with the selected contact. The user may also select an option to save the selected contact in the user's address book. In another example, the user may select one of the names from the list 242, and user device 120 may dial the phone number associated with the selected name, initiate the creation of an SMS message associated with the selected name, or initiate the creation of an email message associated with the selected name, etc. In yet another example, directory system 100 may not send the associated phone numbers with list 242. User device 120 may send a call request back to directory system 100 in response to the user selecting one of the names. Directory system 100 then may call the phone number associated with the selected name from list 242.

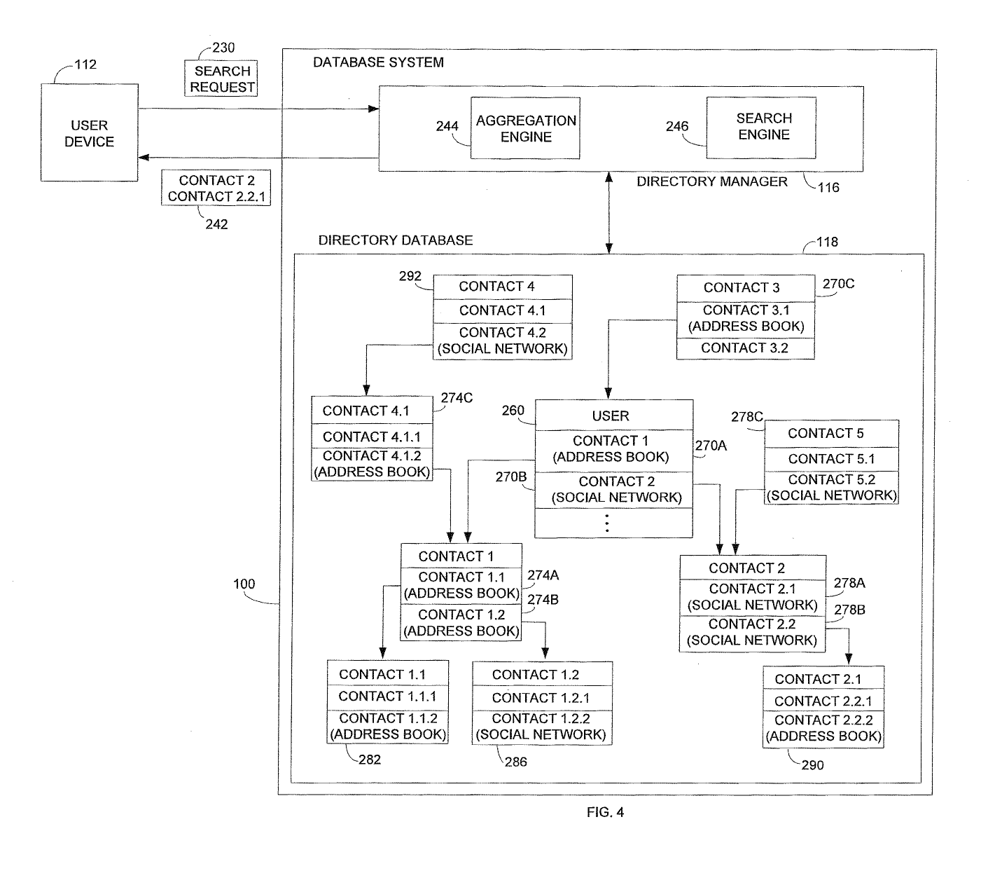

FIG. 4 depicts an example of conceptual relationships between different contact information in directory database 118. A particular user 260 may have an associated user profile in profile table 256 of FIG. 3. Contact 270A may have been uploaded from an address book of user 260 and contact 270B may have been uploaded from a social network for user 260. Contact 270C may have user 260 in its address book or social network while user 260 may not have contact 270C in its address book or social network. Contacts 270A and 270B are directly related to user 260 through the user address book and user social network and are identified as having a first degree of separation from user 260. Contact 270C may also be identified as having a first degree of separation from user 260. However, since user 260 may not have contact 270C in its address book or social network, contact 270C may be ranked lower than contacts 270A and 270B when user 260 performs a search.

Aggregation engine 244 may have also added contacts 274A and 274B from an address book of contact 270A and may have also added contacts 278A and 278B from a social network of contact 270B. Contact 274C may have contact 270A in its address book or social network 272 while contact 270A and user 260 may not have contact 274C in their address books or social networks. Contact 278C may have contact 270B in its address book or social network 276 while contact 270B and user 260 may not have contact 278C in their address books or social networks. Contacts 274A and 274B are indirectly related to user 260 through contact 270A, and contacts 278A and 278B are indirectly related to user 260 through contact 270B. Therefore, contacts 274A, 274B, 278A, and 278B are identified as having a second degree of separation from user 260. Contacts 274C and 278C are indirectly related to user 260 through contacts 270A and 270B and therefore may also be identified as having a second degree of separation from user 260. However, since contacts 270A, 270B, and user 260 may not have contacts 274C and 278C in their address books or social networks, contacts 274C and 278C may be ranked lower than contacts 274A, 274B, 278A, and 278B when user 260 performs a search.

Aggregation engine 244 also may have added contacts 282 into directory database 118 from an address book 280 of contact 274A, added contacts 286 from a social network 284 of contact 274B, and added contacts 290 from an address book 288 of contact 278B. Contact 292 may have contact 274C in its address book or social network while contacts 274C, 270A, and 260 may not have contact 292 in their address books or social networks. Contacts 282, 286, and 290 are indirectly related to user 260 through one level of direct contacts, 270A and 270B, and one level of indirect contacts, 274A, 274B, 278A, and 278B, and are therefore identified as having a third degree of separation from user 260. Contact 292 is indirectly related to user 260 through one level of direct contacts, 270A, and one level of indirect contacts, 274C, and therefore may also be identified as having a third degree of separation from user 260. However, since contacts 274C, 270A, and 260 may not have contact 292 in their address books or social networks, contact 292 may be ranked lower than contacts 282, 286, and 290 when user 260 performs a search.

Search engine 246 may receive a search request 230 from user 260 and search through user contacts in directory database 118. In one example, search engine 246 may identify names for contacts 270B, 274A, 274C, and 290 matching search request 230. The name associated with contact 270B has a first degree of separation from user 260, the name associated with contact 274A has a second degree of separation from user 260, the name associated with contact 274C has a second degree of separation from user 260, and the name associated with one of contacts 290 has a third degree of separation from user 260. Search engine 246 may generate a name list 242 in response to search request 230 that ranks the names associated with the identified contacts in the following order: the name associated with contact 270B followed by the names associated with contacts 274A, 274C, and 290, in that order.

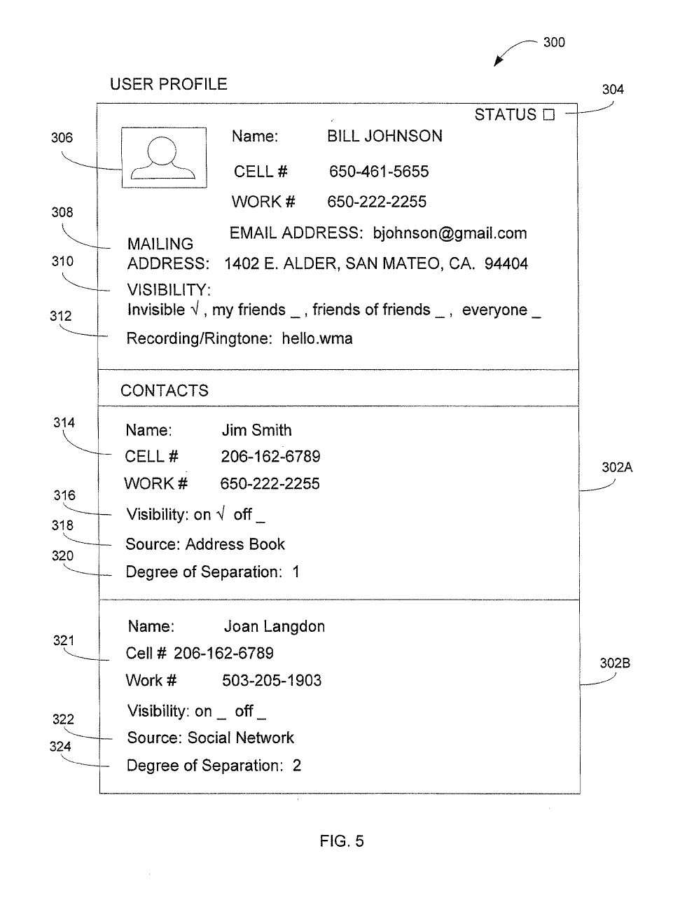

FIG. 5 depicts an example of a user profile 300 in the directory database. The aggregation engine may generate profile tables, directory records, and/or connection tables associated with user profile 300. User profile 300 may contain personal user contact information 308 such as a name, a cell phone number, a work number, an email address, and/or a mailing address.

User profile 300 also may include a visibility setting 310 indicating different levels of visibility for contact information 308 or contact information for other contacts 302. For example, a name in personal user contact information 308, or a name in contact information 314 of contact 302A, may match a search request. The directory system may display a phone number or address from the contact information 308 or 314 to the searcher based on visibility settings 310. Visibility setting 310 may direct the directory system to only display personal contact information 308 to direct contacts of the user (e.g., friends), indirect contacts of the user (e.g., friends of friends), everyone, or to no one (e.g., invisible).

User profile 300 also may include an image 306 and/or a recording 312 associated with the user. For example, image 306 may be a picture of the user and recording 312 may be a personal greeting recorded of the voice of the user. The directory system may attach photograph 306 or play recording 312 when the user initiates a phone call, text message, or email message.

For example, the user associated with user profile 300 may select a name from a list of names provided by the directory system in response to a user initiated search request. The directory system may call a phone number associated with the name selected by the user, or may call a phone number selected by the user associated with the selected name. The directory system may play recording 312 and/or display image 306 in a manner similar to playing a ring tone or displaying a caller Id while connecting to the phone number. This provides more audio and/or visual information about the user/caller prior to someone answering the phone call or receiving the message.

User profile 300 also may include user status setting 304, such as a do not disturb (DND) setting, or settings indicating the user is out of the office, away from the desk, on the telephone, etc. The directory system may prevent calls to the user when DND setting is enabled. In another example, the directory system may prevent selected calls to the user based on DND setting. For example, the directory system may only initiate calls to the user from contacts identified in user profile 300. In another example, the directory system may send the phone numbers in personal contact information 308 to a DND directory in response to selecting DND setting 304. In another example, the directory system may forward calls from the user's business phone to the user's mobile phone when user status setting 304 indicates the user is out of the office or away from the desk. User status setting 304 may be set by the user or automatically determined by the directory system when the directory system has access to information regarding the state of the user's mobile device, computer, telephone, etc. In yet another example, user status setting 304 may be associated with a “Do Not Call” list.

User profile 300 also may link to contacts 302 associated with the user. For example, contact 302A may be uploaded from the user address book. Contact 302A may include contact information 314, such as a name, different phone numbers, and an email address. A visibility setting 316 may determine when contact information 314 is displayed during a phone call or message to contact 302A. For example, the directory system may not display contact information 314 to a caller when visibility setting 316 is turned off. In another example, visibility setting 316 may be similar to visibility setting 310 and display contact information 314 based on a relationship of the caller with the owner of user profile 300.

A source identifier 318 may identify a source of contact 302A. For example, source identifier 318 may indicate contact 302A came from an address book of the user. A degree of separation identifier 320 may indicate a degree of separation between contact 302A and the owner of user profile 300. Contact 302A has one degree of separation since contact 302A came from the address book of the user/owner of user profile 300.

A second contact 302B is linked to user profile 300 and has contact information 321 for a second person or company. In this example, a source identifier 322 indicates contact 302B came from a social network and separation identifier 324 indicates contact 302B has two degrees of separation from the owner of user profile 300.

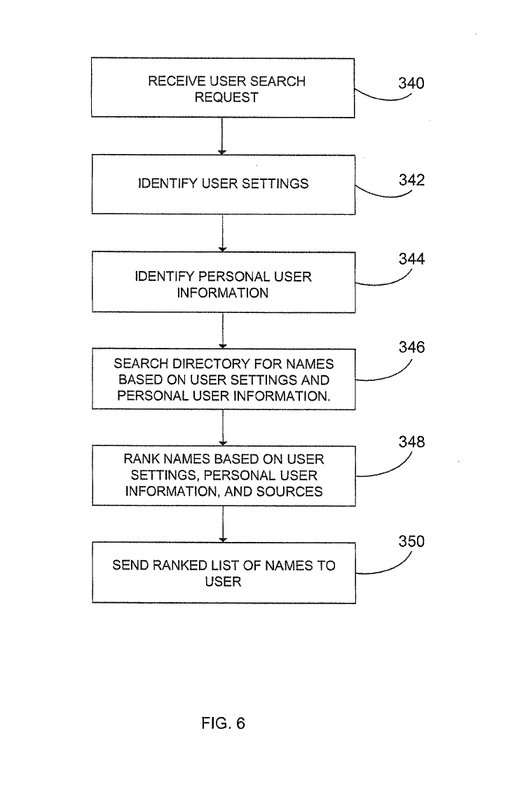

FIG. 6 depicts an example of a process for searching a directory. In operation 340, the directory system may receive a search request from a user. The search request may comprise a name, a mailing address, an internet address, or any other identifier associated with a particular entity. In operation 342, the directory system may identify any user settings associated with the user or the search request. For example, the user may select a particular category for the search request, such as, for companies, people, particular sources, time periods, or locations. The user settings also may request the directory system to conduct the search based on a current location of the user. In this example, the device being operated by the user may contain a GPS system that provides geographic location information along with the search request.

In operation 344, the directory system may search the user profile on the directory database for information about the user that may be used during a database search. For example, the directory system may use a mailing address of the user to identify matching contact information within a same general area of the user.

In operation 346, the directory system may perform a search based on the user settings and personal user information. For example, the directory system may search for a matching name associated with a company, a person, a location, a degree of separation from the user, etc. In one example, the directory system may search for contact information from a particular source or contact information having a particular relationship to the user. For example, the directory system may search for matches in the contact information downloaded from contacts in the user address book and then search for matches in the contact information from the address books of the contacts. The directory system then may search for contact information associated with other sources.

In operation 348, the directory system may rank the matching contact information based on the user settings, personal user information, and sources associated with the identified contact information. For example, contact information coming from an address book may be ranked higher than contact information coming from a social network. In operation 350, the directory system may send a ranked list of names to the user. For example, the name with a highest ranking may be listed first and a name with a second highest ranking may be listed second.

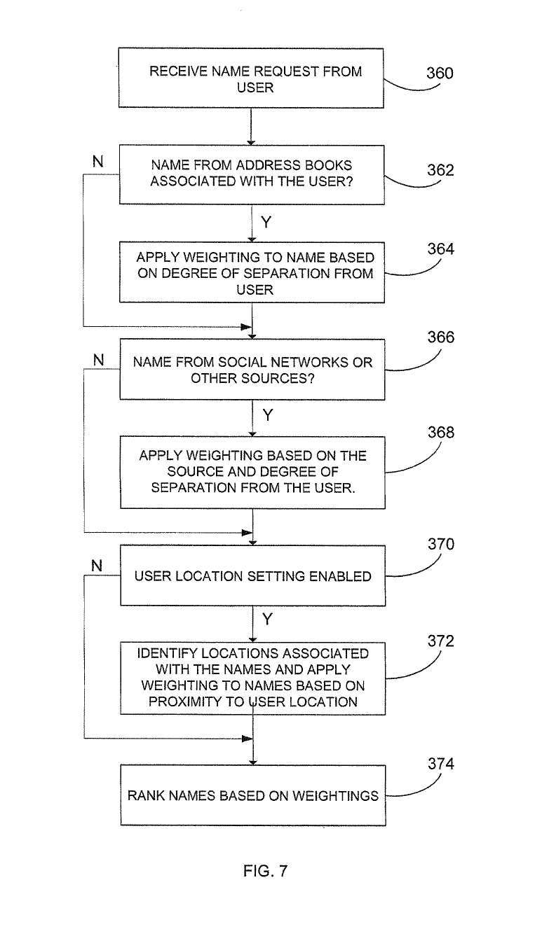

FIG. 7 depicts an example of a process for ranking search results. In operation 360, the directory system may receive a search request from a user. In operation 362, the directory system may identify matching names from address books associated with the user. For example, the directory system may search for matching names in the contact information originating from with the address books of the user, the address books for the friends of the user, and the address books for the friends of friends of the user. In operation 364, any identified matching names may be assigned a weighting based on the degree of separation from the user. For example, matching names identified in the user address book may be assigned a higher weighting than matching names identified in the address book of a friend.

In operation 366, the directory system may identify matching names from social networks or from other third party and global sources. For example, the directory system may identify matching names in contact information from a first recreation social network where the user is a member, a second business social network where only the friends of the user are members, and from a global database where no relationship exists between the user and any of the contact information.

In operation 368, any matching names may be assigned weightings based on the source associated with the name and/or the degree of separation, if any, between the user and the name. For example, names associated with a social network where the user is a member may be assigned a higher weighting than names associated with a social network where the user is not a member. In another example, names associated with a business social network may be assigned a higher weighting than names associated with a recreational social network. Any matching names originating from a global database and having no relationship to the user may be assigned a lowest weighting.

In operation 370, the directory system may check for any other user settings that may affect the weightings. For example, the user may have requested a location based search. In operation 372, the directory system may determine locations associated with the matching names and compare those locations to a user location. For example, the directory system may look for mailing addresses, area codes, zip codes, etc. in the contact information for the matching names.

Weightings may be assigned to the matching names, or currently assigned weightings may be adjusted, based on the proximity of the matching names. For example, matching names having associated locations closer to the user may be assigned a higher weighting than the matching names having associated locations further away from the user. In operation 374, the directory system may rank the names based on their assigned weightings. For example, the names with the higher weighting may be ranked higher than names with lower weightings. The ranked list of names is then sent to the user.

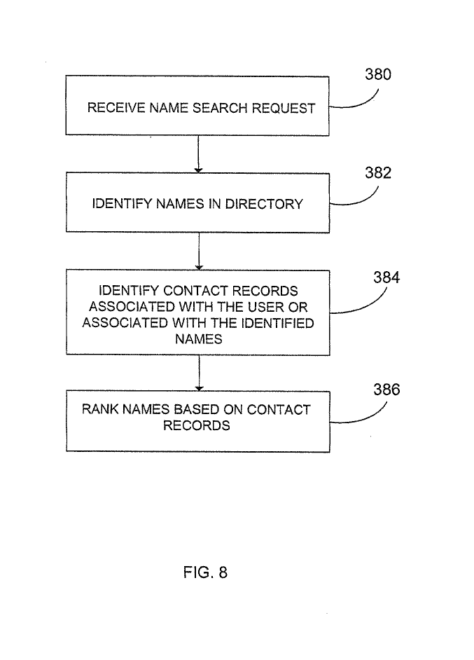

FIG. 8 depicts an example of a process for ranking search results based on contact records, such as call records, SMS records, email records, etc. In operation 380, the directory system may receive a search request from a user. In one example, the search request may identify a name. The directory system may search for contact information in the directory database for names matching with the name in the search request.

In operation 384, the directory system may identify contact records associated either with the user or associated with the matching names identified by the directory system. For example, the directory system may compare the contact records of the user with the matching names identified by the directory system. Matches may indicate phone numbers previously called by the user or phone numbers that previously called the user. In another example, the directory system may compare the contact records associated with the matching names with the contacts from the user address book. Any matches may indicate a relationship between an acquaintance of the user and the person associated with the matching name.

In operation 386, the directory system may rank the matching names based on the contact records. For example, any matching names having associated contact records indicating some direct or indirect relationship with the user may be ranked higher than other matching names. In another example, contact records identifying names the user has most recently contacted or been contacted by may be ranked higher than other matching names the user has not recently contacted or has not recently been contacted by. In another example, contact records identifying names the user has frequently contacted or been contacted by may be ranked higher than other matching names the user has less frequently contacted or been contacted by.

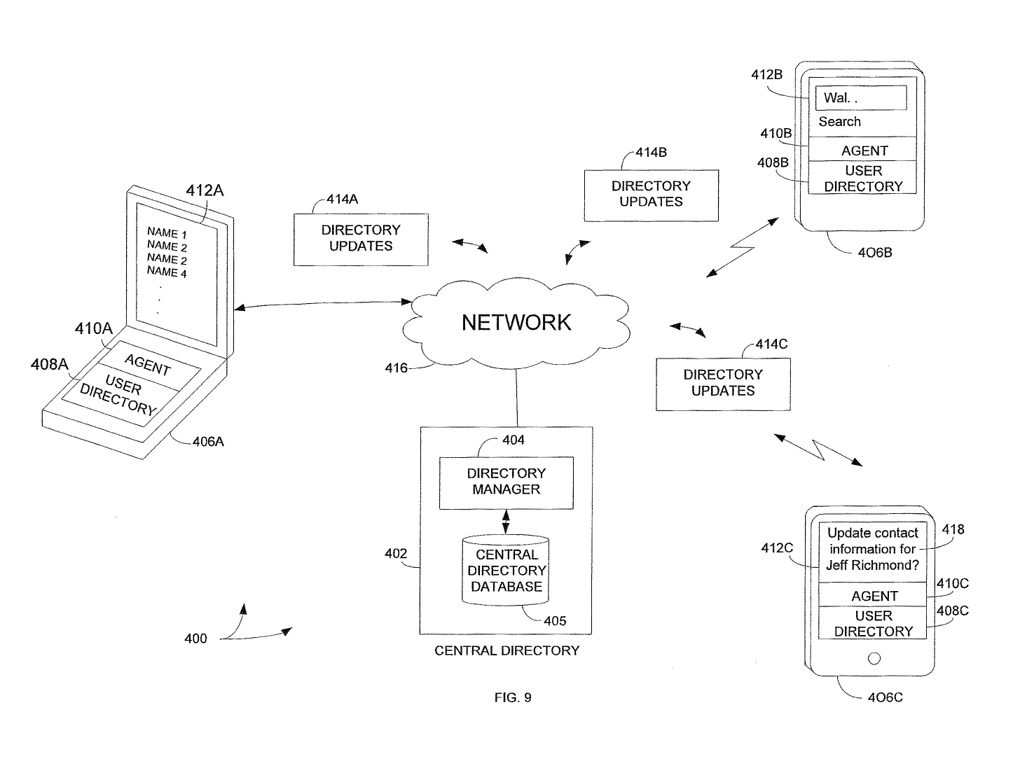

FIG. 9 depicts an example of a distributed directory system 400. Distributed directory system 400 may comprise a central directory 402 that includes a directory manager 404 and a central directory database 405. User devices 406 may be connected to the central directory 402 via a network 416. Network 416 may comprise any combination of wired networks, wireless networks, Internet networks, phone networks, or the like, or any combination thereof. User devices 406 may comprise mobile devices, phones, personal computers, terminals or any other computing device that can access directory information. For example, user device 406A may comprise a laptop computer with a user interface 412A, and user devices 406B and 406C may comprise smart phones with user interfaces 412B and 412C, respectively.

Portions of the directory may be distributed on the user devices 406 as user directories 408. User directories 408 may contain contact information associated with the users of devices 406. For example, user directory 408A may contain an aggregation of the contact information from the address book of the user associated with user device 406A, social networks and other third party sources where the user is a member, and other contact information within some degree of separation from the user.

Central directory database 405 may retain all of the contact information from user directories 408 as well as any other contact information obtained from other third party sources or other global databases. In another example, some of the contact information in user directories 408 may only be stored locally in user devices 406 and may not be stored in central directory database 405.

Agents 410 in user devices 406 may be configured to operate in conjunction with directory manager 404 in central directory 402. In another example, agents 410 also may operate autonomously from central directory 402. In this example, agents 410 may operate with associated user directories 408 in the same user device, or user directories 408 within the same enterprise network, in a similar manner as directory manager 404 operates in conjunction with central directory database 405. For example, agent 410B may independently aggregate contact information from different sources into user directory 408B and may independently search and rank the contact information in user directory 408B.

In one example, agents 410 and directory manager 404 are configured to synchronize contact information in central directory database 405 and in user directories 408. For example, the user of device 406C may change some contact information in user directory 408C. Agent 410C may send the contact information changes as directory updates 414C to central directory 402. Directory manager 404 then may update the corresponding contact information in central directory database 405. In another example, other directory records in central directory database 405 may need to be updated.

In another example, directory manager 404 may detect contact information changes in central directory database 405 and send corresponding directory updates 414 to user devices 406. For example, directory updates 414A sent by user device 406A may have changed the personal contact information for the user of device 406A. The contact information for the user of device 406A also may be contained in user directory 408C of user device 406C. Directory manager 404 may send directory updates 414C to user device 406C containing the changes in the user contact information. Agent 410C may generate a message 418 on user interface 412C identifying the updates to the user contact information. Agent 410C may update the user contact information in user directory 408C when authorized by the user of user device 406C.

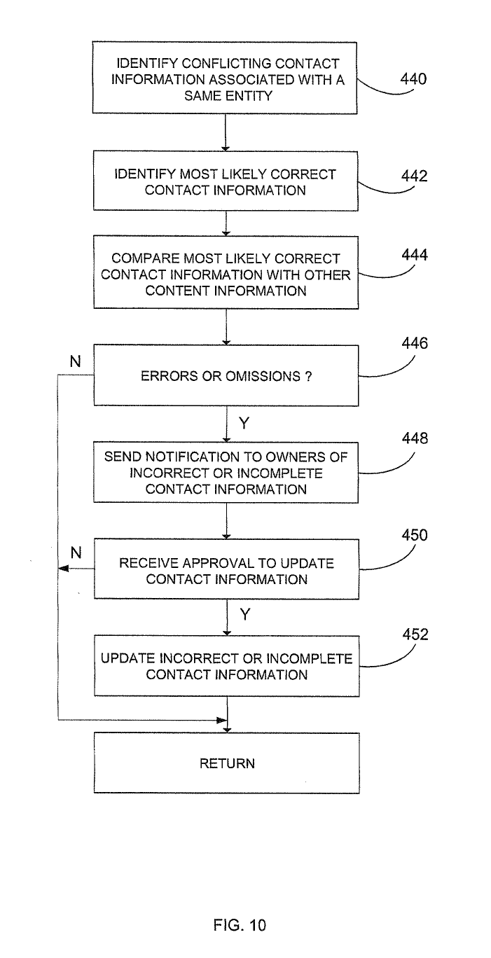

FIG. 10 depicts an example of a process for synchronizing contact information. In operation 440, the directory system may identify conflicting contact information associated with a same entity. For example, address books for different users may be uploaded to the directory system and may contain contact information for the same person. The cell phone number for the person may be the same in the two address books, but the business phone numbers for the person uploaded from the two address books may be different. In another example, address books may contain different, but not conflicting, contact information for the same person, in which case the different contact information may be merged into a “virtual” contact for the person. When the person registers as a user of the directory system, the person's contact information may be prepopulated with information from the “virtual” contact for the person.

Where conflicting contact information is identified, in operation 442, the most likely correct contact information may be identified. For example, the business phone number in the personal profile of the actual person having the business phone number may be considered the most likely correct number. In another example, four different sources may have a same first business phone number for a person and one source may have a second different business phone number for the person. The first business phone number may be considered the most likely correct number since multiple sources have the same number. In yet another example, time stamps may be associated with the contact information. The time stamp identifying the most recently changed business phone number for the person may be considered the most likely correct number.

In operation 444, the mostly likely correct contact information is compared with other contact information in a central database directory or compared with contact information in distributed user directories. For example, the most likely correct business phone number is compared with contact information in directory records that may be associated with the same person.

In operation 446, any errors or omissions may be identified. For example, the contact information for a first directory record may have an outdated business phone number for the person. In another example, contact information may only include a cell phone number or an email address for the person, but no business phone number. In operation 448, the directory system may send notifications to owners of the incorrect or incomplete contact information. For example, the notification may be sent to the owner of an account in the database system associated with the incorrect contact information. The notification may identify a current business phone number in the contact information and identify the new most likely correct business phone number.

The business phone number may be updated in operation 452 in response to approval by the account owner of the incorrect or incomplete contact information in operation 450. For example, the changes may be accepted by selecting an icon displayed on a user interface of a user device and the new business phone number may be added or may replace a current business phone number.

The identified most likely correct contact information identified in operation 442 may not be correct. For example, the notification in operation 448 may be sent to the person who actually uses/owns the identified business phone number. The owner may verify that the identified business phone number is actually incorrect and that the business phone number in the user profile for the owner is correct. Additional notifications may be sent out to other users with the correct business phone number identified by the owner.

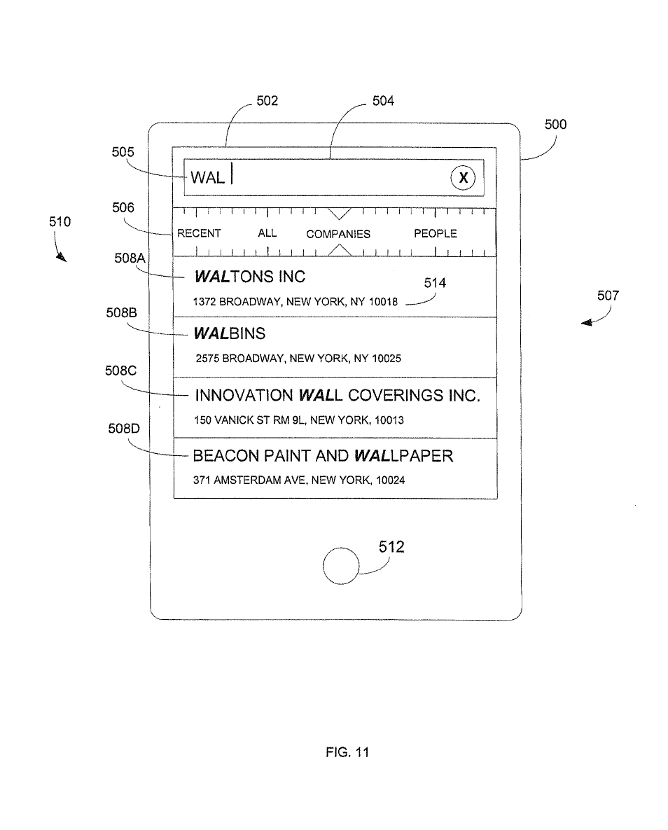

FIG. 11 depicts an example of a user device 500 configured to display a ranked list of names for companies. A screen 502 is configured to display information and receive user inputs. A selection button 512 may display applications operating on device 500. An application 507 may be configured to access locally stored contact information, such as contacts from a user address book. Application 507 also may be configured to access contact information located remotely on a central directory system. Application 507 also may configure user settings both in user device 500 and in a user profile located in the central directory system.

In one example, application 507 may comprise a web application operating on a web server and device 500 may access the web application via a web browser. In another example, application 507 may comprise an agent operating on user device 500 configured to operate in conjunction with a web application operating on the web server. In yet another example, application 507 may be an application operating independently on user device 500 that communicates with the central directory system.

Application 507 may display a search field 504 for entering a search term 505. In one example, the search term 505 may be all or part of a name. In other examples, the search term may be associated with a phone number, mailing address, email address, etc. A rotating drum image 506 may display different search categories. Search categories may comprise a recent category, an all category, a companies category, and a people category. Any other categories may be used and included on rotating drum 506. In this example, rotating drum image 506 has been set to the companies category.

Application 507 may receive and display a list 510 in response to the entry of search term 505 into search field 504. In one example, the user may not have entered the entire name associated with search term 505 prior to application 507 receiving and displaying list 510. List 510 may identify names 508 and associated addresses 514 for companies matching search term 505. For example, matching names 508 include the three letters WAL from search term 505. Names 508 may be ranked in list 510 based on relationships with the user of device 500. For example, names 508A and 508B may be associated with contacts in the address book or social networks of the user and names 508C and 508D may be associated with contacts in the address books of friends of the user. Therefore, list 510 may be more likely to contain the correct name.

List 510 may identify names that the user may not be able to distinguish from a large list of unranked names provided by an on-line white pages directory or identified by a general purpose Internet search engine. Names 508 also may be identified more quickly since searching can be directed to a smaller database of contact information with some established relationship to the user. Thus, application 507 receives and displays a list of search results customized for the particular user that initiates the search request.

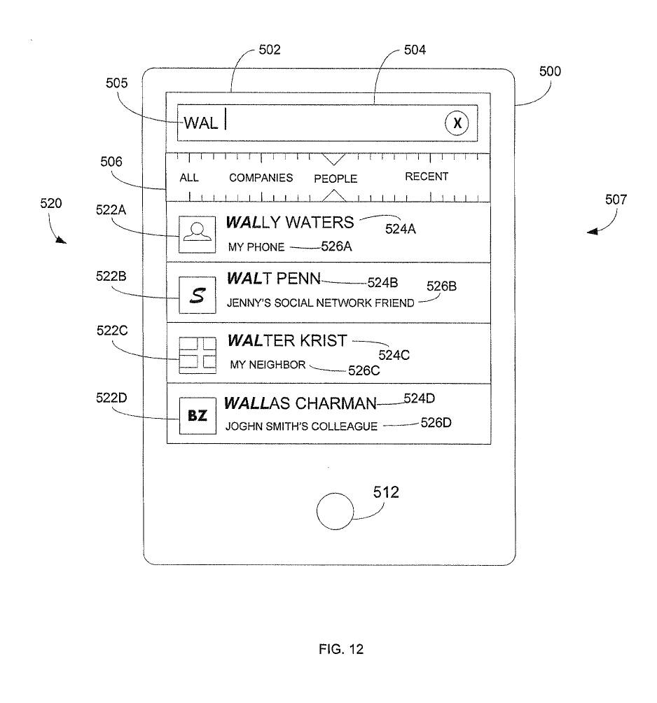

FIG. 12 depicts an example of a device configured to display a ranked list of names for people. In one example, rotating drum image 506 may be set to the people category and a same search term WAL may be entered into search field 504. Application 507 may receive and display a list 520 of names 524 ranked based on their relationship to the user entering search term 505.

For example, name 524A may be associated with a contact in an address book stored in device 500 and name 524B may be associated with a contact in a social network for a friend of the user. The friend of the user may be identified as a contact in the user address book. Name 524C may be related to the user by location. For example, personal contact information for the user may include a home address. Name 524C may have an associated address in a same neighborhood as the home address for the user. Name 524D may be a colleague of a friend of the user. For example, name 524D may be two degrees of separation from the user and may come from an address book for a contact of the user.

Icons 522 may identify associated sources for names 524. For example, icon 522A may be displayed adjacent to name 524A and identify a user address book stored in device 500 or stored on an enterprise server accessed by device 500. A relationship identifier 526A may further identify the source of name 524A or identify the relationship between name 524 and the user. For example, relationship identifier 526A may identify name 524A as coming from the address book of the user.

It should be understood that contact information including name 524A may have originated from an address book in device 500 but may not actually come from the address book. For example, the contact information containing name 524A may be stored in a central database system and sent back to user device 500 in response to a search request. User device 500 may periodically upload contact information updates from the address book to the central directory. Similarly, contact information from social networks and other third party databases may be periodically uploaded to the central database system and then sent to device 500 in response to search requests.

Similar icons 522B, 522C, and 522D and relationship identifiers 526B, 526C, and 526D may identify the sources and relationships between the user and names 524B, 524C, and 524D, respectively. For example, icon 522B may identify a social network where name 524B originated and relationship identifier 526B may indicate name 524B originated from a social network and is associated with the contacts for a friend of a friend of the user.

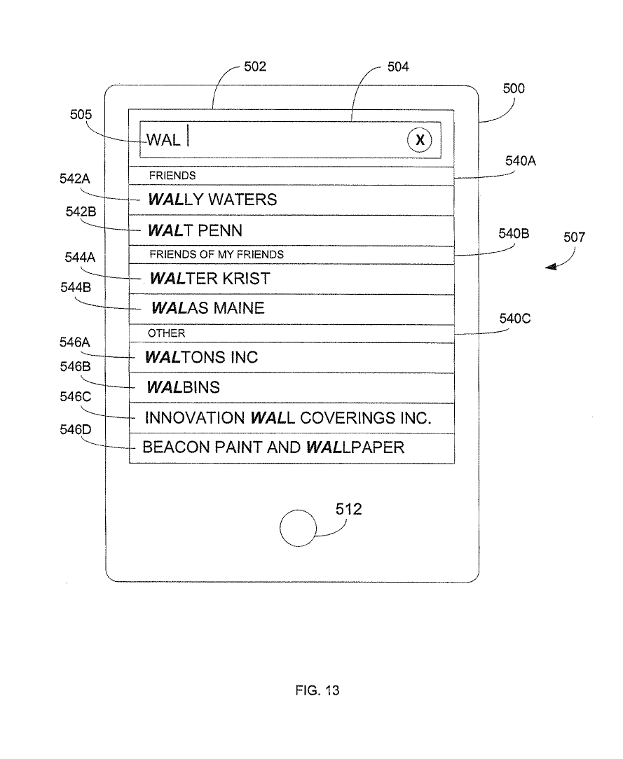

FIG. 13 depicts an example of a device configured to display multiple ranked lists. A previously displayed rotating drum image 506 may be set to all and a same search term WAL may be entered into search field 504. Application 507 may receive and display a first list 540A for a friends category. List 540A may include names 542A and 542B of people in the user address book having a first degree of separation with the user. A “friends” tag can be assigned by the user to contacts and list 540A may display the matching names with the friends tag.

The user may designate any other categories for lists by assigning associated tags to contact information. For example, application 507 may receive and display a second list 540B for a “friends of my friends” category. List 540B may include matching names 544A and 544B of people having a second degree of separation from the user. The “friends of my friends” category may be created by the user assigning associated tags to contacts. List 540B then may include names matching the letters WAL that have the “friends of my friends” tag. In another example, the directory system may identify matching names and automatically generate list 540B for the matching names that are two degrees of separation from the user.

Application 507 may display a third list 540C for an “other” category. List 540C may include matching names 546A-546D that do not fit within the categories in lists 540A and 540B. In one example, names 546 in list 540C may be ranked based on other relationships with the user. For example, name 546A may be associated with a company including the letters WAL that was last phoned by the user, or that called the user. Name 546B may be associated with a second to last company that includes the letters WAL that was phoned by the user or that called the user.

In another example, name 546C may be associated with a company closest in distance to the user that includes the letters WAL and name 546C may be associated with a company second closest in distance to the user that includes the letters WAL. In yet another example, names 546A-546D that are also contacts in the user address book may be ranked higher in list 540C than companies not contained in the user address book.

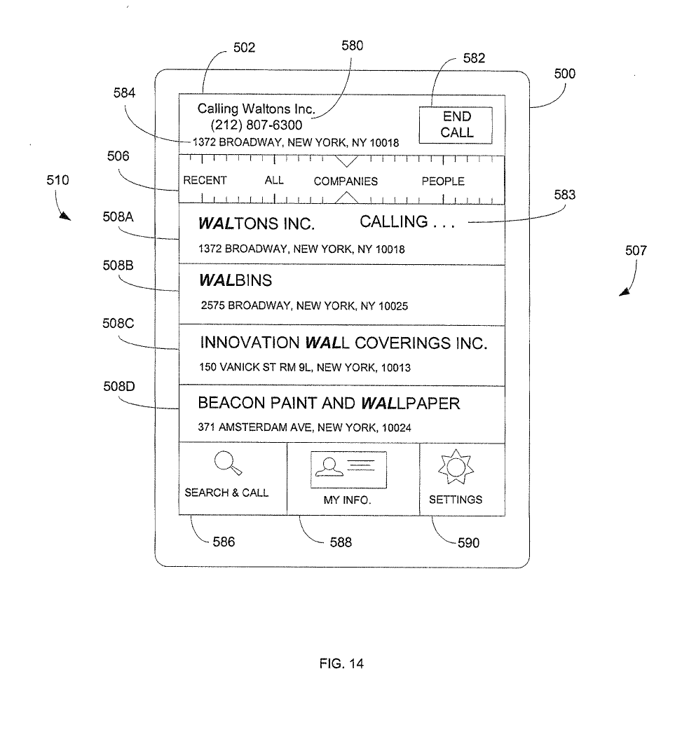

FIG. 14 depicts an example of a device configured to initiate calls to displayed phone numbers. A user may select one of names 508 displayed on screen 502. For example, a call may be made to a phone number 580 in response to selection of name 508A in list 510. The call may be initiated from device 500 or from the directory system. For example, a user directory or address book in device 500 may contain name 508A and associated phone number 580 and device 500 may make a direct call to phone number 580. In another example, the database system may contain name 508A and associated phone number 580. Device 500 may send a call request to the database system in response to selection of name 508A and the directory system may make the call to phone number 580. In yet another example, the directory system may send phone number 580 back to device 500 and device 500 may make the call to phone number 580.

Phone number 580 and address 584 are associated with name 508A and may be displayed on screen 502 based on an associated visibility setting. For example, the user account or profile in the directory system providing/owning name 508A may have set a visibility setting for name 508A to invisible. Whenever name 508A is displayed or selected, the directory system may detect the invisible setting and not display phone number 580. In this example, the directory system still may call phone number 580 in response to selection of name 508A, but may not send and/or display phone number 580 and/or address 584 on screen 502 of device 500. The call can be terminated by selecting an end call icon 582.

Application 507 also may display control icons 586, 588, and 590 within screen 502. Selection of a “search and call” icon 586 may display rotating drum image 506 and search field 504 previously shown in FIGS. 11-13. A “my information” icon 588 may cause application 507 to display fields for entering personal contact information and contact information for other address book contacts into the directory system. Selection of “settings” icon 590 may cause application 507 to display fields for changing settings for a user profile in the directory system.

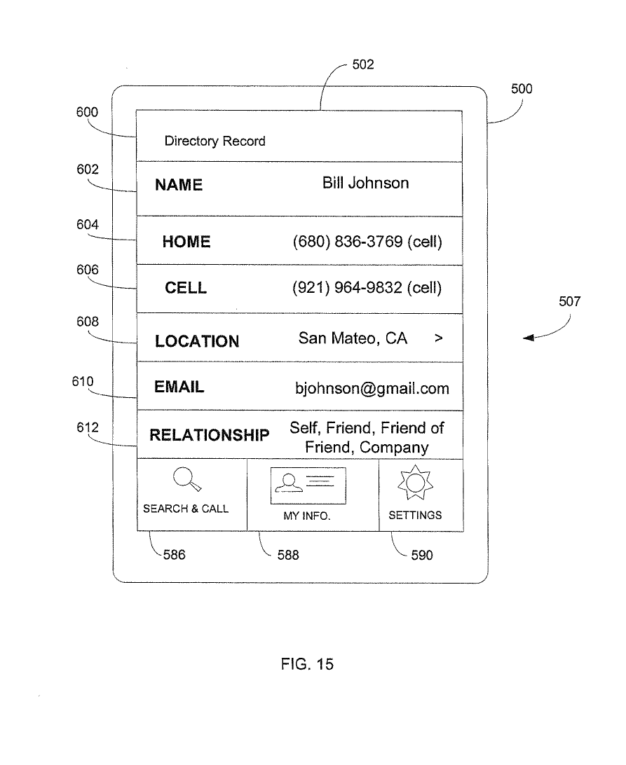

FIG. 15 depicts an example of a device configured to create a directory record in the directory system. Application 507 may display directory record 600 in response to selection of the “my information” icon 588. Contact information entered into directory record 600 may be personal contact information for the user or may be contact information for an affiliate of the user. For example, directory record 600 may contain contact information for a friend of the user or for a company affiliated with the user.

Contact information entered in to directory record 600 may be uploaded to the directory database 188 in directory system 100 shown in FIG. 1. In another example, the contact information also may be stored in a user address book or a user directory located locally in device 500 or located in an enterprise server associated with the user.

A name field 602 is configured to receive a name. If the name currently exists in the directory system or in an address book stored in device 500, application 507 may automatically populate other fields in directory record 600 with any existing contact information associated with the name. For example, an address book in device 500 may contain a contact that includes the name Bill Johnson and a cell phone number. Application 507 may populate field 606 with the cell phone number from the address book. A home field 604 is configured to receive a home phone number and the cell field 606 is configured to receive a cell phone number. A location field 608 is configured to receive a mailing address and an email field 610 is configured to receive an email address.

Relationship field 612 is configured to identify a relationship between the user and the contact information entered into directory record 600. In one example, the personal contact information of the user may be entered into directory record 600. The user may select a “self” tag in relationship field 612 to indicate the contact information is the personal contact information of the user. In another example, contact information entered into directory record 600 may be associated with a friend of the user. Accordingly, the user may select a “friend” tag in relationship field 612.

Any other tags may be used in relationship field 612 to identify relationships between the user and contact information entered into directory record 600. For example, a “friend of friend” tag, “family” tag, “sibling” tag, or a “company” tag may be selected in relationship field 612 and assigned to directory record 600. In another example, more than one tag may be selected in field 612 to identify multiple relationships between the user and the contact information in directory record 600. In one example, application 507 may automatically assign tags to directory records 600. For example, when the name entered into name field 602 is also contained in a user address book, application 507 may assign a “first degree of separation” tag or a “friend tag” to directory record 600. In another example, if two users have the same contact tagged with a “mother” tag, the two users' contacts for each other may be tagged with a “sibling” tag. In yet another example, if two users have contacts for each other each tagged with a “sibling” tag, but only the first user has a contact tagged with a “father” tag, the contact may be added to the second user's list of contacts with a “father” tag.

The directory system may use the tags for conducting searches in response to search requests. As explained earlier, directory records with tags identifying particular relationships with the user may be searched for contact information matching a search request. Further, any matching contact information found in the directory records may be ranked or listed in the search results based on the relationships identified by the tags.

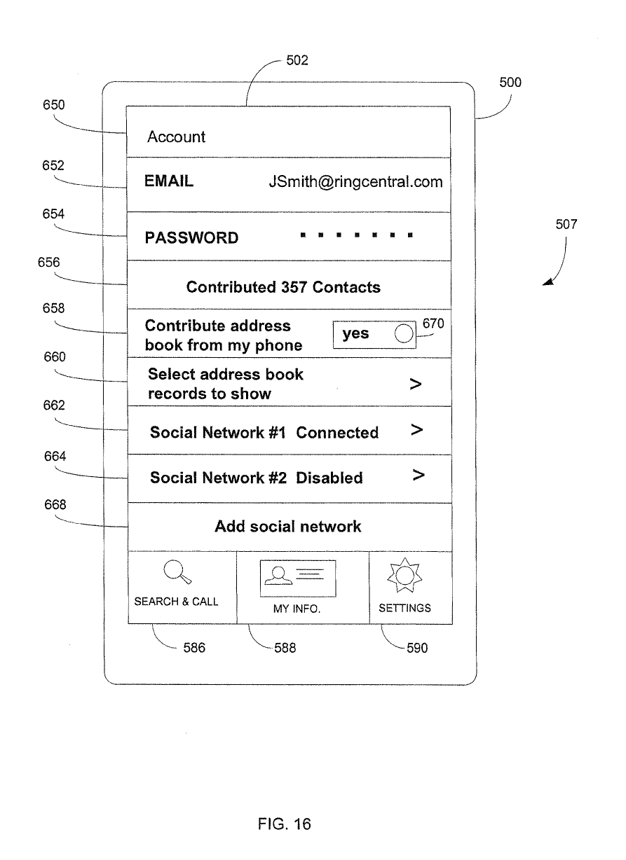

FIG. 16 depicts an example of a device configured to access an account 650 in the directory system. The account screen 650 may be displayed in response to selection of settings icon 590. A user may enter an email address into an email field 652 and enter a password into a password field 654 to access the account in the directory system. Upon access to the directory system, the user may add or change personal contact information and user settings in the account, or may add and change contact information for other contacts. In one example, the settings in account 650 may be stored in the user profile 300 shown in FIG. 5.

A contribution field 656 may show the number of contacts from the user address book uploaded to the directory system. For example, contribution field 656 shows 357 contacts from the user address book have been uploaded to the directory system. A selection icon 670 in contribute field 658 may be selected to enable uploading of contact information from the user address book to the directory system. A select address book field 660 may be selected to display contacts from the user address book for uploading to the directory system.

Social network fields 662 and 664 may identify different social networks where the user is a member. Contact information from the social networks identified in fields 662 and 664 may be downloaded by the directory system. For example, enabling social network field 662 may display a list of contacts for the user on the associated social network for uploading to the directory system. In another example, enabling field 662 may cause the directory system to automatically download contact information from a user profile on the identified social network. An add social network field 668 may be selected to add additional social networks for downloading contact information.

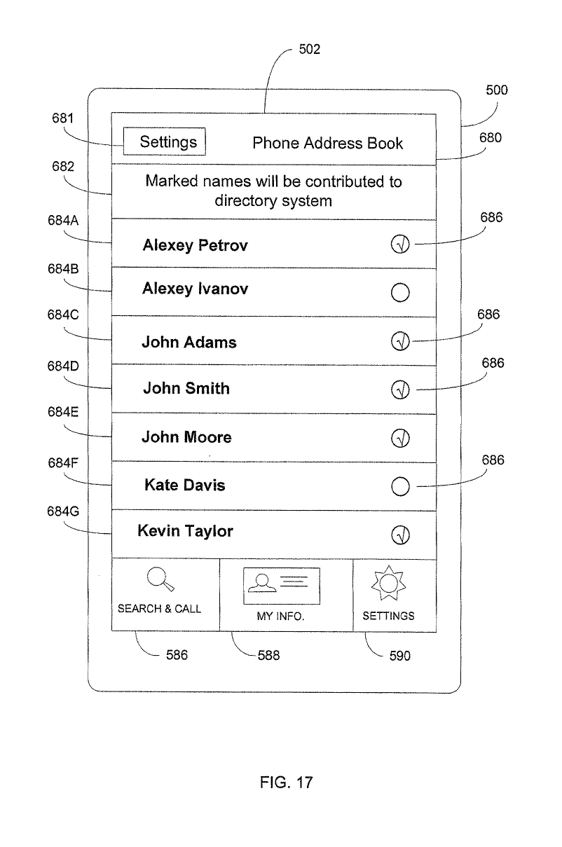

FIG. 17 depicts an example of a device configured to select contacts from an address book for uploading to the directory system. Address book 680 may be displayed in response to select address book field 660 in FIG. 16. Names 684 may be displayed for different contacts contained in address book 680. A display section 682 may notify the user that the contact information for selected names 684 may be uploaded to the directory system.

Selection of one of icons 686 adjacent to one of names 684 cause device 500 to upload associated contact information to the directory system. For example, the directory system may create a directory record in the directory system that contains contact information from the user address book 680 associated with the selected name 684. The directory system also may identify relationships between the user and the uploaded contacts. For example, any uploaded contact information from address book 680 may be identified as having one degree of separation from the user. A settings icon 681 may be selected to change visibility settings for the contact information.

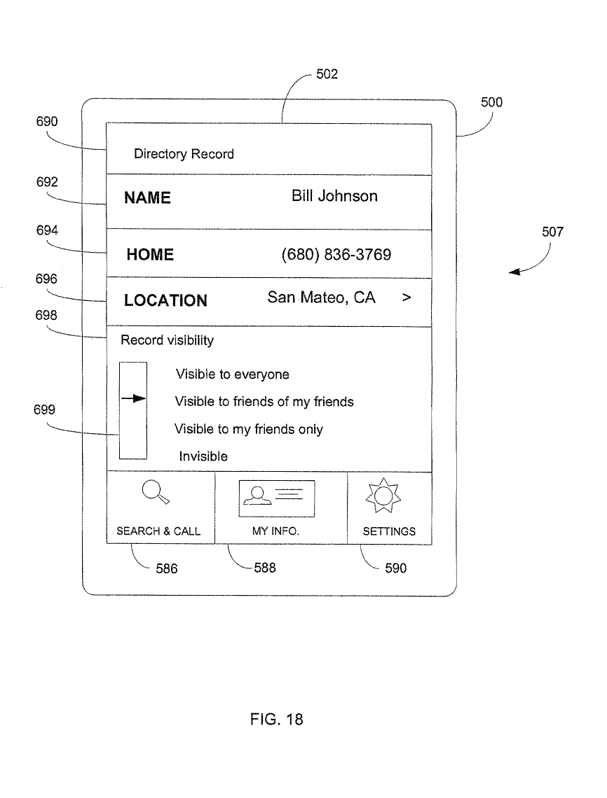

FIG. 18 depicts an example of a device configured to control a visibility setting for a directory record. A directory record 690 may be displayed in response to selection of a setting icon 681 for a selected name 684 shown in FIG. 17. A name field 692 may identify the name associated with directory record 690. Home field 694 may display a home phone number for the directory record and location field 696 may display a mailing address for the directory record.

A record visibility field 698 may identify a current visibility setting for directory record 690 or for individual fields of directory record 690, such as name 692, home phone number 694, or location 696. The user may change the visibility setting for directory record 690 by moving a slider bar 699. Directory record 690 may contain the personal contact information of the user or may contain contact information for other contacts associated with the user, such as a friend in the user address book. The user may not want the contact information for the friend to be visible to other users of the directory system. Accordingly, the user may move slider bar 699 to an invisible setting. The invisibility setting will prevent the directory system from display contact information for the friend to any other users. For example, the directory system will not display the home phone in number field 694 or the home mailing address in location field 694 to callers.

In one example, the directory system still may search and display the name in name field 692 when the name matches a name request. The directory system also may call the home phone number in field 694 in response to selection of the name. However, the phone number and address in directory record 690 may not be visible to the caller.

Other visibility settings may be configured using slider bar 699. For example, contact information may be visible only to friends of the user by moving slider bar 699 to a second “visible to my friends only” position. The directory system then may determine a relationship between the caller and the owner of directory record 690. The phone number and mailing address in directory record 690 may not be displayed when the caller is not within one degree of separation from the owner of directory record 690. For example, the phone number and mailing address in directory record 690 will not be displayed when the caller is not tagged as a friend of the owner of directory record 690 or the caller is not one of the contacts in the address book of the owner of directory record 690.

Other record visibility settings may be selected by moving slider bar 699. For example, a third position for slider bar 699 may only display the contact information in directory record 690 to friends of the friends of the owner of directory record 690. The contact information in directory record 690 may be made visible to any user of the directory system by moving slider bar 699 to a fourth “visible to anyone” position.

The interface described above allows quick signup to the directory system. Fields from previously created directory records may be pre-populated based on permission settings and privacy settings can be individually assigned to different directory records 690. In one example, a name, location, and age may be visible by default. Contacts from a user address book can be displayed and automatically uploaded to the directory system and a meter can show the number of contacts from the address book contributed to the directory system. A user also can integrate contact information from third party sources, such as social networks, into the directory system. A user may have different levels of access to the directory system depending on the number of contacts or the identity of contacts the user has contributed to the directory system. The directory system can then perform searches based on a name, phone number, contact, etc. across the contacts uploaded from multiple different users. An auto-complete feature quickly identifies matching contact information. Categories can be selected to further filter search results. The search results can also be grouped based on tags or other relationships to the user, such as friends, friend of friends, companies, other, etc.

The directory system provides a personalized ranking system that determines relationships between the user and the matching contact information and determines the most likely correct contact information for search queries. For example, search results may be ranked according degrees of separation between the user and the contacts, location, etc. Selection of contact information identified in search results may automatically dial a phone number, initiate a call to a phone number, send an email or text message, etc.

The system and apparatus described above may use dedicated processor systems, micro-controllers, programmable logic devices, microprocessors, or the like, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise a storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

Having described and illustrated the principles of various examples, it should be apparent that the examples may be modified in arrangement and detail without departing from such principles. Claim is made to all modifications and variations coming within the spirit and scope of the following claims.

1. A method, comprising:
receiving, by a computing device, a search request from a user;
searching, by the computing device, a directory in response to the search request;
identifying, by the computing device, contacts from the directory based on the search request;
identifying, by the computing device, degrees of separation between the user and the contacts;
determining, by the computing device, a first weighting for the contacts based on the degrees of separation between the user and the contact;
identifying, by the computing device, data sources providing the contacts;
determining, by the computing device, a second weighting for the contacts based on the data sources providing the contacts; and
ranking, by the computing device, the contacts based on the first weightings and the second weightings.

2. The method of claim 1, further comprising:
identifying a first number of the contacts identifying a first name associated with the search request;
identifying a second number of contacts containing a second name associated with the search request; and
ranking the first name higher than the second name based on the first number of the contacts being larger than the second number of the contacts.

3. The method of claim 1, further comprising:
identifying a first name in a first one of the contacts associated with the search request;
identifying a first degree of separation between the user and the first one of the contacts;
identifying a name of the user in the contacts for the first one of the contacts;
identifying a second name in a second one of the contacts associated with the search request;
identifying a first degree of separation between the user and the second one of the contacts;
determining the name of the user is not in the contacts for the second one of the contacts; and
ranking the first name in the first one of the contacts with a first degree of separation higher than the second name in the second one of the contacts with a first degree of separation.

4. The method of claim 1, further comprising:
identifying a first one of the contacts in an address book of the user and having a first degree of separation with the user;
identifying a second one of the contacts not in the address book of the user and having a first degree of separation with the user; and
ranking the first one of the contacts higher than the second one of the contacts.

5. The method of claim 1, further comprising: identifying a number of common entries in address books of the contacts and in an address book of the user; and
ranking the contacts based on the number of common entries.

6. The method of claim 5, further comprising uploading some of the contacts into the directory from a global database containing caller identifiers and associated phone numbers.

7. The method of claim 1, further comprising:
receiving tags identifying relationships between the contacts and the user;
identifying different groups of the contacts associated with the identified relationships; and
displaying the different groups of the contacts to the user.

8. The method of claim 1, further comprising:
identifying the contacts in the directory associated with a same entity;
identifying differences between contact information in the identified contacts; and
selectively updating the contact information to remove the differences.

9. The method of claim 1, further comprising:
listing names associated with the identified contacts;
receiving a request to initiate a communication for a selected one of the names; and
initiating a communication in response to the request.

10. The method of claim 1, further comprising:
listing names associated with the identified contacts;
receiving a request from the user to dial a phone number for a selected one of the names;
identifying a recording in the directory associated with the user; and
playing the recording while calling the phone number.

11. An apparatus, comprising:
logic circuitry configured to:
receive a search request from a user;
identify names and associated contact information in response to the search request;
enable the names to be displayed to the user;
identify visibility settings for the contact information;
enable the contact information to be displayed to the user based on the visibility settings;
receive a selection of one of the displayed names;
identify a phone number in the contact information associated with the selected one of the displayed names;
identify a shut off state for the visibility settings of the contact information associated with the selected one of the displayed names; and
use the hone number to initiate a phone call while preventing the hone number from being displayed to the user based on the shut off state for the visibility settings.

12. The apparatus of claim 11, wherein the logic circuitry is further configured to:
identify relationships between the user and entities associated with the contact information; and
enable the contact information to be displayed based on the relationships between the user and the entities associated with the contact information.

13. The apparatus of claim 12, wherein the relationships comprise degrees of separation between the user and the entities associated with the contact information.

14. (canceled)

15. The apparatus of claim 11, wherein the logic circuitry is further configured to:
identify a do not disturb setting in the contact information associated with the selected one of the displayed names; and
prevent initiation of the phone call based on the do not disturb setting.

16. The apparatus of claim 11, wherein the logic circuitry is further configured to:
identify relationships between the user and entities associated with the displayed names; and
display the relationships with the displayed names.

17. The apparatus of claim 11, wherein the logic circuitry is further configured to:
identify a first set of the contact information associated with contacts in a user address book;
identify a second set of the contact information associated with address books of the contacts;
identify a first set of names in the first set of the contact information based on the search request;
identify a second set of names in the second set of the contact information based on the search request;
display the first set of names in a first ranked list; and
display the second set of names in a second ranked list.

18. The apparatus of claim 17, wherein the logic circuitry is further configured to:
identify a third set of the contact information associated with social network sites for the user;
identify a third set of names in the third set of the contact information associated with the social network sites based on the search request; and
display the third set of names in a third ranked list.

19. The apparatus of claim 11, wherein the logic circuitry is further configured to:
identify a user location;
identify contact locations associated with the contact information; and
identify the contact information based on a proximity of the contact locations to the user location.

20. The apparatus of claim 11, wherein the logic circuitry is further configured to:
receive tags identifying relationships between entities associated with the contact information and the user; and
display the contact information to the user based on the relationships.

21. The apparatus of claim 11, wherein the logic circuitry is further configured to:
display a list of names in response to the search request;
receive a name selection for one of the names from the list of names;
initiate a communication associated with the name selection;
identify a recording associated with the user; and
play the recording while calling the phone number to identify the user.

22. An apparatus, comprising:
a processing device configured to:
identify contact information for different users;
generate records in a directory associated with the different users and containing the contact information;
compare the contact information in the records associated with the different users;
identify differences in the contact information;
identify the contact information most likely to be correct contact information;
identify the contact information most likely to be incorrect contact information; and
update the incorrect contact information with the correct contact information.

23. The apparatus of claim 22, wherein the processing device is configured to:
identify different phone numbers in the contact information for an entity;
identify one of the users as the entity;
identifying one of the different phone numbers in the contact information for the identified one of the users as a most likely correct phone number for the entity; and
identify the other different phone numbers in the contact information for the other users as most likely incorrect phone numbers for the entity.

24. The apparatus of claim 22, wherein the processing device is further configured to:
identify a phone number in the contact information for an entity;
identify the records for a first group of the users having a first phone number for the entity;
identify the records for a second group of the users having a second phone number for the entity;
identify a larger number of the users in the first group of users than in the second group of users; and
identify the first phone number as a most likely correct hone number for the entity based on the larger group of users in the first group of users.

25. The apparatus of claim 22, wherein the processing device is further configured to:
send notifications to the different users identifying the differences in the contact information; and
replace the mostly likely to be incorrect contact information with the most likely to be correct contact information in the records associated with the different users in response to approval by the different users or identification of new contact by the different users.

26. The apparatus of claim 22, wherein the processing device is further configured to:
identify omitted contact information in the records associated with the different users; and
add the omitted contact information from the most likely to be correct contact information to the records associated with the different users.

27. The apparatus of claim 22, wherein the processing device is further configured to:
receive a search request from an identified one of the different users;
send the search request to the directory; and
receive a list of contact information back from the directory in response to the search request, wherein the list of contact information is ranked in an order based on relationships between the identified one of the different users and the contact information.

28. The apparatus of claim 27, wherein the processing device is further configured to:
identify a category for the search request; and
receive a list of contact information back from the directory for the identified category.

29. The apparatus of claim 27, wherein the processing device is further configured to display different ranked lists of contact information having different relationships with the identified one of the different users.

30. The apparatus of claim 22, wherein the processing device is further configured to:
initiate a search query in the directory;
receive a list of names back from the directory in response to the search query;
receive a selection for one of the names from the list of names; and
initiate a call to the selected one of the names.
